(19) United States
(12) Patent Application Publication
(10) Pub. No.: US 2014/0132854 A1
(43) Pub. Date: May 15, 2014

(54) TOUCH DISPLAY DEVICE

(71) Applicant: HannStar Display Corporation, New Taipei City (TW)

(72) Inventors: JIONG TING WU, Tainan City (TW); CHIN WEI LIN, Tainan City (TW)

(73) Assignee: HannStar Display Corporation, New Taipei City (TW)

(21) Appl. No.: 14/056,001

(22) Filed: Oct. 17, 2013

(30) Foreign Application Priority Data
Nov. 13, 2012 (CN) 201210452758.X

(51) Int. Cl. G06F 1/16; G09G 5/00

(52) U.S. Cl. CPC G06F 1/169; G09G 5/006
USPC 349/12

(57) ABSTRACT

A touch display device includes a protective layer, a display layer and a touch layer. The protective layer includes a display region and a non-display region located around the display region. The display layer is disposed under the protective layer. The touch layer is disposed under the display layer or between the protective layer and the display layer, whereby both of the display region and the non-display region have the touch function.

### CROSS-REFERENCE TO RELATED APPLICATION

This application claims the benefit of China Patent Application No. 201210452758.X, filed on Nov. 13, 2012, which is hereby incorporated by reference for all purposes as if fully set forth herein.

### BACKGROUND OF THE INVENTION

1. Field of Invention

This invention relates to a touch display device, and more particularly to a touch display device whose a display region and a non-display region both have a touch function.

2. Related Art

A touch display device has been accepted by the people to become an interface tool for transmitting the information to each other, and is a consuming electronic product which can integrate many functions. For example, tablet computer, personal digital assistant (PDA), smart phone, etc. are adapted to input the information in a touch manner.

Referring to FIG. 1, a conventional touch display device 900 (e.g., smart phone) has a touch region 910 corresponding to a display region 920 of the touch display device 900, whereby an user can slide or contact the display region 920 by a finger or a touch screen pen so as to control the touch display device 900. A non-display region 930 of the touch display device 900 has a push-button type icon 940 and a camera lens 950.

Recently, the push-button type icon 940 has a push-button structure, and thus the electronic product can carry out the corresponding touch function in a push-button manner. Most camera lens 950 only has a function of taking photos. Generally, the camera lens 950 is designed to be located at an edge of the non-display region 930 of the touch display device 900, and the push-button type icon 940 is designed to be located at the other edge of the non-display region 930 of the touch display device 900, such that the area of the display region 920 is restricted, and thus the touch display device 900 can be inconveniently used by the user.

Accordingly, there exists a need for a touch display device which can increase the area of the display region and can be conveniently used by the user so as to be capable of solving the above-mentioned problems.

### SUMMARY OF THE INVENTION

It is an objective of the present invention to provide a touch display device which can increase the area of a touch layer and include a non-display region having a touch function.

In order to achieve the objective, the present invention provides a touch display device including a protective layer comprising a display region and a non-display region located around the display region; a display layer disposed under the protective layer; and a touch layer disposed under the display layer or between the protective layer and the display layer, wherein the touch layer is extended to the position where is located under the display region and the non-display region, whereby the display region and the non-display region both have the touch function.

The present invention discloses that the protective layer includes at least one icon located on the non-display region, and the icon is a touch type icon or a virtual type icon.

The present invention discloses that the protective layer includes a camera lens for capturing images, and the touch display device controls a picture of the display region according to the images.

According to the touch display device of the present invention, the touch layer is extended to the position where is located under the non-display region, and thus the non-display region of the touch display device also has the touch function. The user can control a picture of the display region or carry out a specific work by using the touch function of the non-display region. Furthermore, the user can utilize the touch type icon or the virtual type icon to carry out the specific touch function of the non-display region so as to control a picture of the display region or carry out a specific work. The touch type icon or the virtual type icon of the present invention can replace the conventional push-bottom type icon, whereby the area of the display region can be increased, and the user can conveniently use the touch type icon or the virtual type icon. In addition, the touch display device of the present invention also utilizes the camera lens to have a function of capturing images, and is integrates with the non-display region having the touch function so as to control a picture of the display region or carry out a specific work.

In order to make the aforementioned and other objectives, features and advantages of the present invention comprehensible, embodiments are described in detail below with reference to the accompanying drawings.

### BRIEF DESCRIPTION OF THE DRAWINGS

FIG. 1 is a top view of a conventional touch display device;

FIG. 2 is a perspective exploded view of a touch display device according to the first embodiment of the present invention;

FIG. 3 is a perspective exploded view of a touch display device according to the second embodiment of the present invention;

FIG. 4 is a top view of a touch display device according to an embodiment of the present invention; and

FIG. 5, it is a top view of a touch display device according to another embodiment of the present invention.

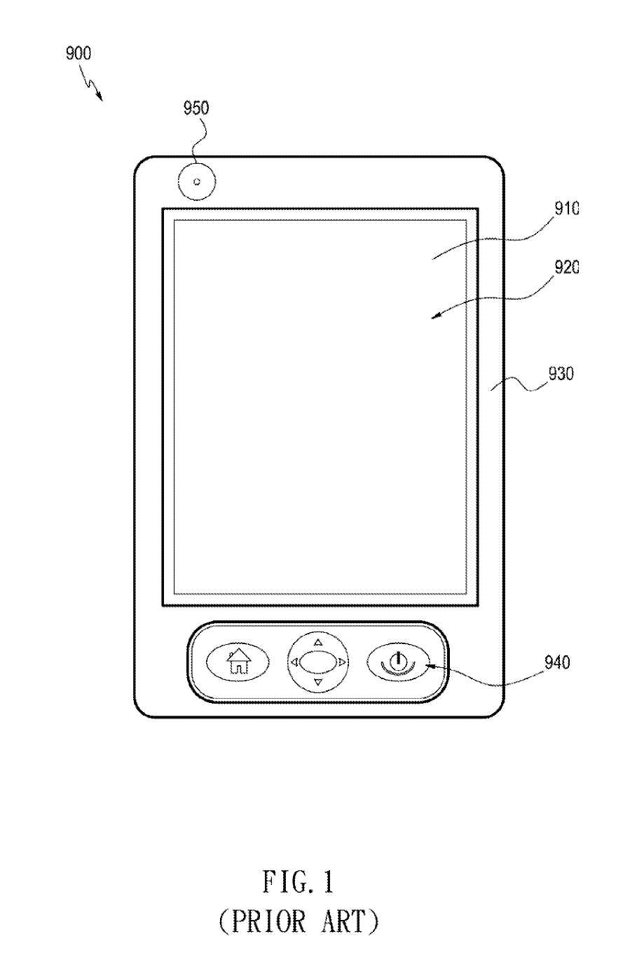

The present invention will become more fully understood from the detailed description given herein below for illustration only, and thus are not limitative of the present invention, and wherein:

### DETAILED DESCRIPTION OF THE INVENTION

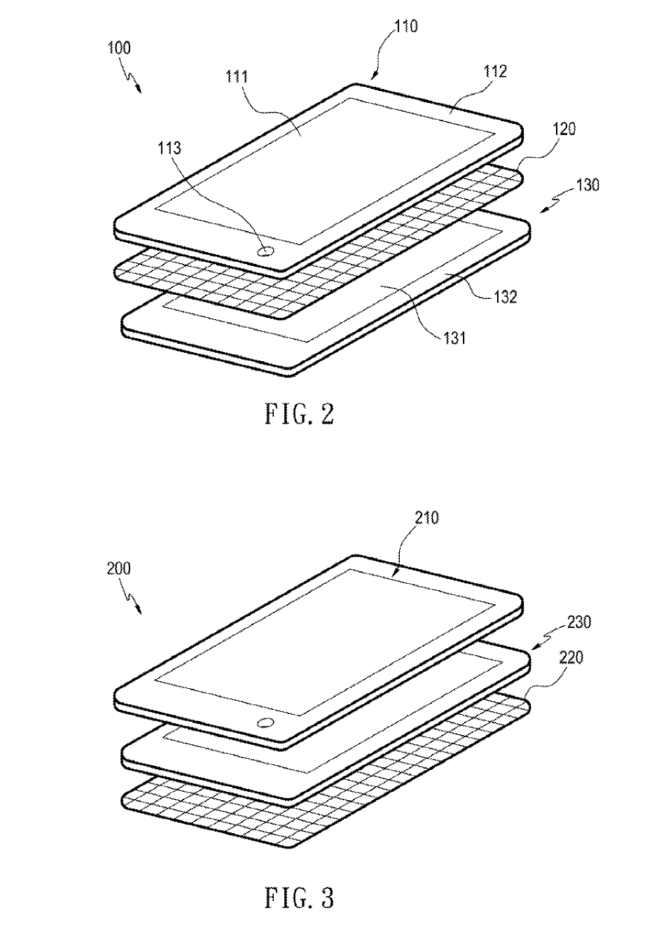

Referring to FIG. 2, it is a perspective exploded view of a touch display device 100 according to the first embodiment of the present invention. The touch display device 100 can be a tablet computer, a personal digital assistant (PDA), a smart phone, etc. which are adapted to input the information in a touch manner. The touch display device 100 includes a protective layer 110, a touch layer 120 and a display layer 130. The protective layer 110 includes a display region 111 and a non-display region 112 located around the display region 111. The non-display region 112 has a hole 113. The display layer 130 includes an image region 131 and a sealant 132, and the sealant 132 is formed around the display layer 130.

The touch layer 120 (e.g., touch panel) is disposed under the protective layer 110. The touch layer 120 can be bonded to the protective layer 110 by a double coated optically clear adhesive (OCA). The touch layer 120 has a plurality of sensing elements, and is extended to a position where is located under the display region 111 and the non-display region 112 of the protective layer 110, whereby the display region 111 and the non-display region 112 both have the touch function. The sensing manner of the touch layer 120 can be optics type, capacitance type or resistance type sensing manner.

The optics type sensing manner is that: optical sensing elements are utilized to detect the variance between images so as to generate a photo current, and a touch position can be determined by an external circuit or other analysis device according to the magnitude of the photo current. The sensing element can be a positive-intrinsic-negative (PIN) diode made elements of group III and group IV in a periodic table of elements.

The capacitance type sensing manner is that: the first conductive lines and the second conductive lines perpendicular to the first conductive lines are provided, and an insulating layer is disposed between the first conductive lines and the second conductive lines. When the user contacts the protective layer 110 by the finger, the finger can change the capacitance value between the first conductive lines and the second conductive lines. An external detecting circuit scans the first conductive lines in order, and detects the changed capacitance of the first conductive lines so as to determine the position in the Y direction. Then, the external detecting circuit also scans the second conductive lines in order, and detects the changed capacitance of the second conductive lines so as to determine the position in the X direction.

The resistance type sensing manner is that: the first substrate and the second substrate are provided, and an insulating layer is disposed between the first conductive lines and the second conductive lines. The first substrate is made of flexible transparent material, and the second substrate is made of rigid transparent material for supporting a pre-determined pressure. The first transparent conductive layer is disposed on the first substrate, the second transparent conductive layer is disposed on the second substrate, and the first transparent conductive layer is corresponding to the second transparent conductive layer. The first substrate and the second substrate are bonded to each other by an adhesive. A plurality of pads are disposed and spaced on the second transparent conductive layer, and the spaced pads have a supporting function, whereby the first transparent conductive layer is electrically isolated from the second transparent conductive layer at the initial state. When the pre-determined pressure is applied to a surface of the protective layer 110, the first transparent conductive layer contacts the second transparent conductive layer. The touch position can be determined by an external circuit or other analysis device, whereby an intention of the user can be acquired according to the display content or picture corresponding to a coordinate position so as to finish the touch function.

The display layer 130 is disposed under the touch layer 120. The display layer 130 can be a display panel, e.g., liquid crystal (LC) display panel or organic light emitting diode (OLED) display panel. The display layer 130 can be bonded to the touch layer 120 by another double coated optically clear adhesive (OCA), whereby the touch layer 120 is located between the protective layer 110 and the display layer 130. The sealant 132 is located underneath the non-display region 112 of the protective layer 110, and the image region 131 is located underneath the display region 111 of the protective layer 110, whereby the image region 131 shows a picture through the display region 111.

Referring to FIG. 3, it is a perspective exploded view of a touch display device 200 according to the second embodiment of the present invention. The touch display device 200 in the second embodiment is substantially similar to the touch display device 100 in the first embodiment, wherein the similar elements are designated with the similar reference numerals.

The difference between the touch display device 200 in the second and touch display device 100 in the first embodiments is: the locations of the display layer 230 and the touch layer 220. The display layer 230 can be disposed under the protective layer 210. The display layer 230 can be bonded to the protective layer 210 by a double coated optically clear adhesive (OCA). The touch layer 220 can be disposed under the display layer 230. The touch layer 220 can be bonded to the display layer 230 by another double coated optically clear adhesive (OCA), whereby the display layer 230 is located between the protective layer 210 and the touch layer 220. The touch layer 220 has a plurality of sensing elements, and is extended to a position where is located under the display region and the non-display region of the protective layer 210, whereby the display region and the non-display region of the protective layer 210 both have the touch function. The sensing manner of the touch layer 220 can be an electromagnetic type sensing manner. The display layer 230 can be a display panel, e.g., liquid crystal (LC) display panel or organic light emitting diode (OLED) display panel.

The electromagnetic type sensing manner is that: an electromagnetic board circuit layer and an electromagnetic pointing unit are generally provided. The electromagnetic board circuit layer (e.g., a flat substrate of the digitizer) includes a plurality of sensor coils constituted by conductors, and is electrically connected to a driving integrated circuit. The electromagnetic pointing unit (e.g., a digital pen or a stylus) includes a resonance circuit for generating an electromagnetic signal. The sensor coils are arranged in the horizontal or vertical directions, and are parallel to or partly overlapped with each other, whereby an electric signal generated by an electromagnetic field between the electromagnetic pointing unit and the sensor coils is detected, and then the driving integrated circuit determines the position of the electromagnetic pointing unit according to the electric signal.

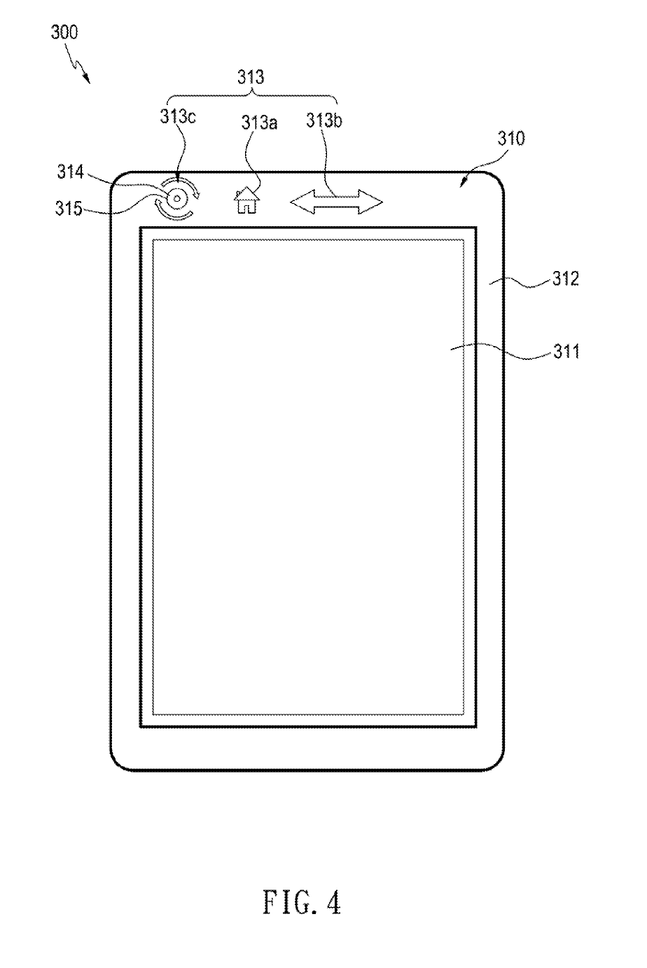

Referring to FIG. 4, it is a top view of a touch display device 300 according to an embodiment of the present invention. The touch display device 300 can be the touch display devices 100, 200 in the first and second embodiments, and the protective layer 310 includes at least one icon (e.g., touch type icon 313) and a camera lens 314, which both are located on the non-display region 312. According to the touch display devices 100, 200 in the first and second embodiments, the touch layer is extended to the position where is located under the non-display region 312 of the protective layer 310, and thus the non-display region 312 of the touch display device 300 also has the touch function. The user can control a picture of the display region 311 or carry out a specific work by using the touch function of the non-display region 312. Specially, the non-display region 312 adjacent to the camera lens 314 can have the touch function. For example, when the finger of the user is slid leftward and rightward, an image of the display region 311 is also moved leftward and rightward according to the sliding direction of the finger, but the embodiment is not limited thereto.

The non-display region 312 also has the touch function, and thus the icon of the non-display region 312 can be a touch type icon 313, and maybe not a push-bottom type icon. More detailed, the touch type icon 313 can be formed on the non-display region 312 of the protective 310 by printing an ink or attaching a sticker, thereby reminding the user of carrying out the specific touch function so as to control a picture of the display region 311 or carry out a specific work.

For example, the touch type icon 313 is the first symbol 313a, which can be a shape of house, whereby when the user touches the touch type icon 313, the picture of the display region 311 can be returned to the initial picture of starting the touch display device 300 by processing signals in the touch display device 300. For example again, the touch type icon 313 is the second symbol 313b, which can be a shape of double arrowheads, whereby when the user touches the touch type icon 313, the picture of the display region 311 can be changed to the previous picture or the next picture. For example again, the non-display region 312 adjacent to the camera lens 314 can have the touch function, and the touch type icon 313 is the third symbol 313c, which can be located around the camera lens 314 and be shown as clockwise arrows, whereby when the user touches the touch type icon 313, the picture of the display region 311 can be enlarged or narrowed. The above-mentioned icons can remind the user of the above-mentioned touch function and shape, but the embodiment is not limited thereto.

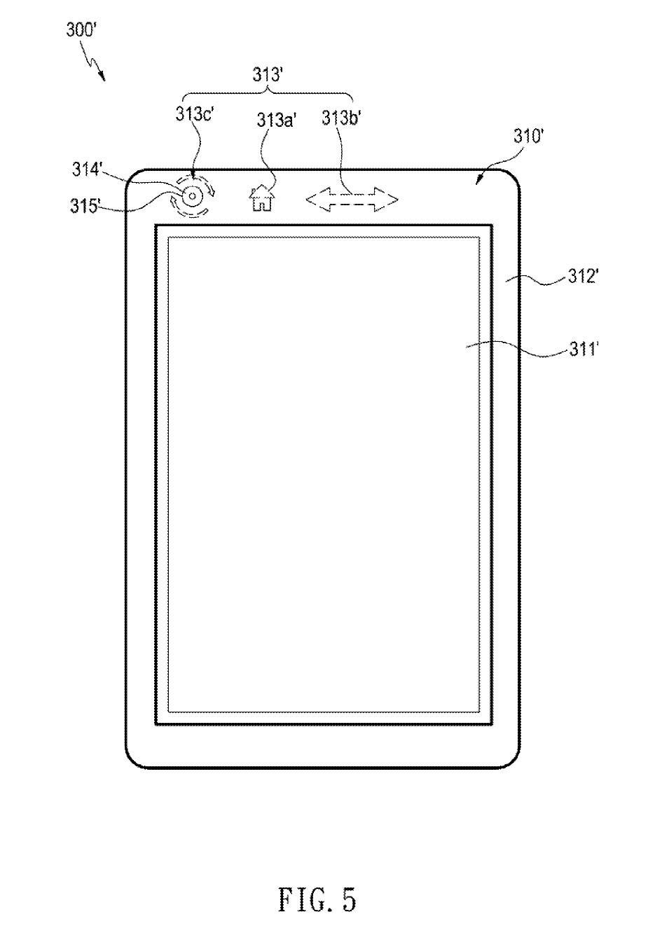

Referring to FIG. 5, it is a top view of a touch display device 300′ according to another embodiment of the present invention. The touch display device 300′ can be the touch display devices 100, 200 in the first and second embodiments, and the protective layer 310 includes at least one virtual type icon 313′ and a camera lens 314′, which both are located on the non-display region 312′. The virtual type icon 313′ is virtual, and cannot be seen on the non-display region 312′ by the user. Thus, the virtual type icon 313′ of FIG. 5 is shown by a dotted line, and the user only read the touch function corresponding to the virtual type icon 313′ in an instruction manual. The user must remember the touch function corresponding to the virtual type icon 313′, and then carry out the specific touch function of the non-display region 312′ so as to control a picture of the display region 311′ or carry out a specific work.

For example, when the user touches the virtual type icon 313a′, the picture of the display region 311′ can be returned to the initial picture of starting the touch display device 300′ by processing signals in the touch display device 300′. For example again, when the user touches the touch type icon 313b′, the picture of the display region 311′ can be changed to the previous picture or the next picture. For example again, when the user touches the touch type icon 313c′, the picture of the display region 311′ can be enlarged or narrowed. The above-mentioned icons can remind the user of the above-mentioned touch function and shape, but the embodiment is not limited thereto.

Referring to FIGS. 4 and 5 again, the camera lens 314, 314′ are disposed in the holes 315, 315′ of the non-display region 312, 312′ respectively for capturing images. The touch display device 300 can control a picture of the display region 311 or carry out a specific work according to the images. For example, when the user shows a gesture in front of the camera lens 314, 314′, the camera lens 314, 314′ captures the image of the gesture so as to control the picture of the display region 311, 311′ by processing signals in the touch display device 300, 300′, e.g., enlarging or narrowing picture, moving picture, brightening or darkening picture, etc., but the embodiment is not limited thereto.

According to the touch display device of the present invention, the touch layer is extended to the position where is located under the non-display region, and thus the non-display region of the touch display device also has the touch function. The user can control a picture of the display region or carry out a specific work by using the touch function of the non-display region. Furthermore, the user can utilize the touch type icon or the virtual type icon to carry out the specific touch function of the non-display region so as to control a picture of the display region or carry out a specific work. The touch type icon or the virtual type icon of the present invention can replace the conventional push-bottom type icon, whereby the area of the display region can be increased, and the user can use the touch type icon or the virtual type icon conveniently. In addition, the touch display device of the present invention also utilizes the camera lens to have a function of capturing images, and is integrates with the non-display region having the touch function so as to control a picture of the display region or carry out a specific work.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A touch display device comprising:
a protective layer comprising a display region and a non-display region located around the display region;
a display layer disposed under the protective layer; and
a touch layer disposed under the display layer or between the protective layer and the display layer, wherein the touch layer is extended to the position where is located under the display region and the non-display region, whereby the display region and the non-display region both have the touch function.

2. The touch display device as claimed in claim 1, wherein the display layer comprises an image region and a sealant, the sealant is formed around the display layer, the image region is located underneath the display region, and the sealant is located underneath the non-display region.

3. The touch display device as claimed in claim 1, wherein the protective layer comprises at least one icon located on the non-display region, and the icon is a touch type icon or a virtual type icon.

4. The touch display device as claimed in claim 3, wherein the touch type icon is formed on the non-display region by printing an ink or attaching a sticker.

5. The touch display device as claimed in claim 3, wherein the touch type icon is a first symbol, whereby when a user touches the touch type icon, the picture of the display region is returned to an initial picture of starting the touch display device.

6. The touch display device as claimed in claim 3, wherein the touch type icon is a second symbol, whereby when a user touches the touch type icon, the picture of the display region is changed to the previous picture or the next picture.

7. The touch display device as claimed in claim 3, wherein the protective layer comprises a camera lens for capturing images, and the touch type icon is a third symbol, which is located around the camera lens, whereby when a user touches the touch type icon, the picture of the display region is enlarged or narrowed.

8. The touch display device as claimed in claim 3, wherein a user only read the touch function corresponding to the virtual type icon in an instruction manual.

9. The touch display device as claimed in claim 1, wherein the protective layer comprises a camera lens for capturing images, and the touch display device controls a picture of the display region according to the images.

10. The touch display device as claimed in claim 9, wherein the non-display region adjacent to the camera lens has the touch function.

11. The touch display device as claimed in claim 1, wherein when a finger of a user is slid leftward and rightward, an image of the display region is also moved leftward and rightward according to the sliding direction of the finger.

12. The touch display device as claimed in claim 1, wherein the display layer is a liquid crystal display panel or an organic light emitting diode display panel.

13. The touch display device as claimed in claim 1, wherein a sensing manner of the touch layer is optics type, capacitance type or resistance type sensing manner.
